(19) United States
(12) Patent Application Publication
(10) Pub. No.: US 2009/0135313 A1
(43) Pub. Date: May 28, 2009

(54) Method for projecting colored video image and system thereof

(76) Inventors: Taro Endo, Tokyo (JP); Yoshihiro Maeda, Tokyo (JP); Hirotoshi Ichikawa, Tokyo (JP); Fusao Ishii, Menlo Park, CA (US)

Correspondence Address: Bo-In Lin, 13445 Mandoli Drive, Los Altos Hills, CA, 94022, US

(21) Appl. No.: 12/313,617

(22) Filed: Nov. 20, 2008

Related U.S. Application Data
(60) Provisional application No. 61/003,936, filed on Nov. 21, 2007.

(51) Int. Cl. H04N 5/74; G03B 21/14

(52) U.S. Cl. 348/757; 353/31; 348/E05.142

(57) ABSTRACT

The present invention provides a method for projecting a colored video image, characterized in that a color-light generation device for generating and projecting at least two light fluxes having at least two different colors wherein the different colors are controlled to change in a time division manner; at least two spatial light modulators receiving and applying input video image date for modulating the light fluxes for generating modulated lights from each of the spatial light modulators; an optical device for combining the modulated lights from the spatial light modulators into a combined modulated light and projecting the combined modulated light; and a controller for controlling the color-light generation device and the spatial light modulators, wherein the controller controls and adjusts a ratio of a modulation period of each color synchronized with a change of the colors of the light fluxes in the time division manner.

### CROSS REFERENCE TO RELATED APPLICATIONS

This application is a Non-provisional Application claiming a Priority date of Nov. 21, 2007 based on a previously filed Provisional Application 61/003,936 and a Non-provisional patent application Ser. No. 11/121,543 filed on May 3, 2005 issued into U.S. Pat. No. 7,268,932. The application Ser. No. 11/121,543 is a Continuation In Part (CIP) Application of three previously filed Applications. These three Applications are Ser. No. 10/698,620 filed on Nov. 1, 2003, Ser. No. 10/699,140 filed on Nov. 1, 2003 now issued into U.S. Pat. No. 6,862,127, and Ser. No. 10/699,143 filed on Nov. 1, 2003 now issued into U.S. Pat. No. 6,903,860 by the Applicant of this patent applications. The disclosures made in these patent applications are hereby incorporated by reference in this patent application.

### BACKGROUND OF THE INVENTION

1. Field of the Invention

The present invention relates generally to a system configuration and method for projecting a colored video image. More particularly, the present invention is related to a color image projection system implemented with a plurality of spatial light modulators for generating a video image, wherein the illumination colors are generated by combining lights of three primary colors projected in a time sequential manner.

2. Description of the Related Art

Technologies for color image display including application of a color sequential method, as that disclosed in U.S. Pat. Publication No. 6,275,271, are widely known. The display lights of R/G/B (i.e., Red/Green/Blue) colors are projected through an optical component such as a color wheel that performs color separation. Then, the R/G/B display light is irradiated onto a single spatial light modulator (SLM) (single panel) typified by a DMD (digital mirror device) in a time sequential manner to generate reflected modulated color lights form the SLM. This reflection light is projected onto a screen or any image display surface to generate a colored display of a video image.

However, this color sequential method has a technical problem of generating an image artifact due to a phenomenon known as a color break. A color break occurs when the viewpoint of a viewer moves rapidly on a screen. A video image resembling a rainbow is momentarily perceived by the viewer and interferes with the viewing of the color images due to the color break effect.

In order to resolve the color break problem, an image projection system may implement a spatial light modulator for each of the primary colors to simultaneously modulate the lights of the three primary colors. The modulated lights of different colors are combined and projected for displaying the color images. The artifacts caused by the color break are eliminated when three spatial light modulators are implemented. In comparison to a display system using a single spatial light modulator for modulating R, G, and B colors, a color image display system that implements a plurality of spatial light modulators also displays a brighter video image display.

For example, U.S. Pat. Publication No. 6,672,722 discloses a projection device that branches light projected from a light source into S-polarized light and P-polarized light. The projection device further arranges kernels for performing a modulation process of R, G, and B light by using two SLMs on a light path of each piece of the polarized light, then combining and projecting output light from each of the kernels at a polarized light combining section. The projection device is intended to project a high-luminance image by reducing the intensity loss of the illumination light projected from the light source.

However, since a total of four SLMs (two for each of the two kernels) are required, the disclosures made in the U.S. Pat. No. 6,672,722 leads to another technical problem in that the structure of the projection device is complicated and the system configuration significantly increase the production costs.

### SUMMARY OF THE INVENTION

One aspect of the present invention is to provide a system configuration and method for projecting a colored video image for display as a bright colored video image that has no image artifacts caused by color break problems. Furthermore, the present invention discloses a color image display system wherein the color break difficulties are resolved without requiring a complicated system configuration; therefore, the system can be manufactured at a reasonable production cost.

A first exemplary embodiment of the present invention provides a color display device, comprising a color-light generation device for generating and projecting at least two light fluxes having at least two different colors wherein the different colors are controlled to change in a time division manner; at least two spatial light modulators receiving and applying input video image date for modulating the light fluxes for generating modulated lights from each of the spatial light modulators;

an optical device for combining the modulated lights from the spatial light modulators into a combined modulated light and projecting the combined modulated light; and a controller for controlling the color-light generation device and the spatial light modulators, wherein the controller controls and adjusts a ratio of a modulation period of each color synchronized with a change of the colors of the light fluxes in the time division manner.

A second exemplary embodiment of the present invention provides the color display device according to the first exemplary embodiment, wherein the color-light generation device comprises a plurality of light sources each irradiate a light flux of a color different from a color irradiated from another light source.

A third exemplary embodiment of the present invention provides the color display device according to the first exemplary embodiment, wherein the color-light generation device comprises a filter device controllable to change a filter characteristic in a time division manner for filtering a light flux to sequentially generate a light flux of different colors according to the time division manner.

A fourth exemplary embodiment of the present invention provides the color display device according to the first exemplary embodiment, wherein the color-light generation device generates and projects a polarized light flux.

A fifth exemplary embodiment of the present invention provides the color display device according to the first exemplary embodiment, wherein the spatial light modulator is controllable to modulate the light flux by changing a modulation time and to generate a modulated light with an adjustable light intensity.

A sixth exemplary embodiment of the present invention provides the color display device according to the first exemplary embodiment, wherein the color-light generation device generates and project light fluxes with at least the two different colors including a primary color or a complementary color generated from the primary color.

A seventh exemplary embodiment of the present invention provides the color display device according to the first exemplary embodiment, wherein the controller controls and adjusts a ratio of a modulation period of each color and then resets the ratio of the modulation period to a predetermined ratio.

An eighth exemplary embodiment of the present invention provides the color display device according to the seventh exemplary embodiment, wherein the controller controls and adjusts a ratio of a modulation period of each color and then resets the ratio of the modulation period to a predetermined ratio wherein the predetermined ratio is determined by taking into account a spectral luminous efficiency of a human eye.

A ninth exemplary embodiment of the present invention provides the color display device according to the first exemplary embodiment, wherein the controller controls and adjusts a ratio of a modulation period of each color and then resets the ratio of the modulation period to a predetermined ratio wherein the predetermined ratio is determined based on a brightness of each color controlled by the input video image data.

A tenth exemplary embodiment of the present invention provides the color display device according to the first exemplary embodiment, wherein the controller controls and adjusts a ratio of a modulation period of each color and then resets the ratio of the modulation period to a predetermined ratio wherein the predetermined ratio is controlled and adjusted according to a number of gray scale gradations for each of the colors wherein the predetermined ratio is for one of the colors is different from the predetermined ratio for another color.

An eleventh exemplary embodiment of the present invention provides the color display device according to the first exemplary embodiment, wherein each of the spatial light modulators further comprises a mirror device for reflecting the light fluxes by controlling a quantity of the reflected light generated in a modulated unit time with at least three different light quantities including a maximum light quantity, an intermediate light quantity, and a minimum light quantity.

A twelfth exemplary embodiment of the present invention provides the color display device according to the first exemplary embodiment, wherein: each of the spatial light modulators further comprises a mirror device for reflecting the light fluxes by controlling a quantity of the reflected light generated in a modulated unit time according to three different states, wherein each of the mirror devices is controlled to operate in an ON state, an OFF state, and an oscillating state; and

the color display device further synchronizes the modulation periods of the two spatial light modulators by controlling sequence and times of the mirror devices to operate in the ON, intermediate and OFF states.

A thirteenth exemplary embodiment of the present invention provides a method for projecting a colored video image from a projection apparatus comprises a first and a second spatial light modulators by executing in one frame of display period operation steps comprising modulating and generating a first modulated light of a primary color from the first spatial light modulator and modulating and generating a second modulated light of a complementary color from the second spatial light modulator and projecting the first and second modulated light to coincide with each other in at least a portion of the one frame of display period; and modulating and generating a third modulated light of a complementary color from the first spatial light modulator and modulating and generating a fourth modulated light of a primary color from the second spatial light modulator and projecting the third and fourth modulated light to coincide with each other in at least a portion of the one frame of display period.

A fourteenth exemplary embodiment of the present invention provides the method for projecting a colored video image according to the thirteenth exemplary embodiment, wherein controlling the first and second spatial light modulators to operate with substantially synchronized display periods.

A fifteenth exemplary embodiment of the present invention provides a method for projecting a colored video image, from a projection apparatus comprises a first and a second spatial light modulators by executing in one frame of display period operation steps comprising modulating and generating a first modulated light of a primary color from the first spatial light modulator and modulating and generating a second modulated light of a complementary color comprising essentially a white color from a second spatial light modulator and combining and projecting the first and second modulated light to coincide with each other in at least a portion of the one frame of display period.

A sixteenth exemplary embodiment of the present invention provides the method for projecting a colored video image according to the fifteenth exemplary embodiment, further comprising a step of: controlling and operating the first and second spatial light modulators to have different gray scale gradations for displaying a color of the essentially white color light and for other colors.

A seventeenth exemplary embodiment of the present invention provides a colored video image projecting system, comprising: a light source for emitting a first and second illumination light; a first mirror device for modulating the first illumination light in a plurality of subframe periods assigned to each color; a second mirror device for modulating the second illumination light in a plurality of subframe periods assigned to each color; a projection optical system for combining the first modulated light modulated by the first mirror device and the second modulated light modulated by the second mirror device for projecting the combined light; a signal processing device for applying input video data to control each of the first and second mirror devices to operate in a first or second state, wherein: The signal processing device adjusts a modulation time when the first mirror device is in the first state, a modulation time when the first mirror device is in the second state, a modulation time when the second mirror device is in the first state, and a modulation time when the second mirror device is in the second state to substantially synchronize each of the subframe periods of the first mirror device and each of the subframe periods of the second mirror device.

An eighteenth exemplary embodiment of the present invention provides the colored video image projecting system according to the seventeenth exemplary embodiment, wherein the projection optical system for combining the first modulated light modulated by the first mirror device and the second modulated light modulated by the second mirror device to generate an essentially white combined light.

A nineteenth exemplary embodiment of the present invention provides the colored video image projecting system according to the seventeenth exemplary embodiment, wherein the light source projects a first and a second illumination lights of substantially a same color.

A twentieth exemplary embodiment of the present invention provides the colored video image projecting system according to the seventeenth exemplary embodiment, wherein each of the first and second mirror devices comprise a mirror, and the signal processing device controls the mirrors to oscillate in the second state.

A twenty-first exemplary embodiment of the present invention provides the colored video image projecting system according to the seventeenth exemplary embodiment, wherein the signal processing device controls the mirror devices to generate an intermediate modulated light between a maximum light quantity and a minimum light quantity in the second state to project a video image with additional levels of controllable light quantities.

A twenty-second exemplary embodiment of the present invention provides the colored video image projecting system according to the seventeenth exemplary embodiment, wherein the signal processing device controls the mirror devices to generate modulated lights of different colors with at least two different gradations of gray scale between modulated lights of different colors from the first and second mirror devices.

Specifically, the present invention discloses a color image display system implemented with two panels, i.e., two spatial light modulators: (SLM). In this two-panel system, each of the panels performs a color sequential modulation for at least one color. The present invention further includes a display device that combines colors generated from two panels generating modulation lights after the processes of color sequential modulations to project a color image. In the present invention, the timing of a color display performed by each of the two SLMs is dynamically controlled and adjusted by combining a light-emission control performed by a laser light source or a similar light source, and an ON/OFF control and an oscillation control performed by the SLMs.

### BRIEF DESCRIPTION OF THE DRAWINGS

The present invention is described in detail below with reference to the following Figures.

FIG. 1 is a functional block diagram showing the configuration of a colored video image projection device executing the method for projecting a colored video image according to one embodiment of the present invention;

FIG. 2 is a functional block diagram showing one example of theory of operation of the colored video image projection device executing the method for projecting a colored video image according to one embodiment of the present invention;

FIG. 3 is a functional block diagram showing one example of theory of operation of the colored video image projection device executing the method for projecting a colored video image according to one embodiment of the present invention;

FIG. 4 is a block diagram showing an exemplary configuration of a control system in the projection display device according to one embodiment of the present invention;

FIG. 5 is a functional block diagram showing an exemplary modification of the colored video image projection device according to one embodiment of the present invention;

FIG. 6 is a functional block diagram showing an exemplary configuration of the colored video image projection device according to another embodiment of the present invention;

FIG. 7 is a functional block diagram showing an example of controlling each of the RIG/B colors of the colored video image projection device illustrated in FIG. 6;

FIG. 8 is a functional block diagram showing an example of controlling each of the R/G/B colors of the colored video image projection device illustrated in FIG. 6;

FIG. 9 is a functional block diagram showing an example of controlling each of the RIG/B colors of the colored video image projection device illustrated in FIG. 6;

FIG. 10 is a functional block diagram showing an example of controlling each of the RIG/B colors of the colored video image projection device illustrated in FIG. 6;

FIG. 11 is a chart showing an example of controlling the colored video image projection device illustrated in FIG. 6 in which a modulation caused by ON/OFF control of the mirror of an SLM and a modulation caused by an oscillation are combined;

FIG. 12 is a functional block diagram showing an exemplary configuration of a pixel section configuring the spatial light modulator according to one embodiment of the present invention;

FIG. 13A is a functional block diagram showing an exemplary configuration of the pixel array of the spatial light modulator according to one embodiment of the present invention;

FIG. 13B is a diagram showing a relationship between voltage applied to an electrode and the state of a micromirror of the spatial light modulator according to one embodiment of the present invention;

FIG. 14A is a diagram showing an example of controlling the ON state of the micromirror;

FIG. 14B is a diagram showing an example of controlling the OFF state of the micromirror; and

FIG. 14C is a diagram showing an example of controlling the oscillating state of the micromirror.

### DESCRIPTION OF THE PREFERRED EMBODIMENTS

The embodiment of the present invention will be described below in detail with reference to the drawings.

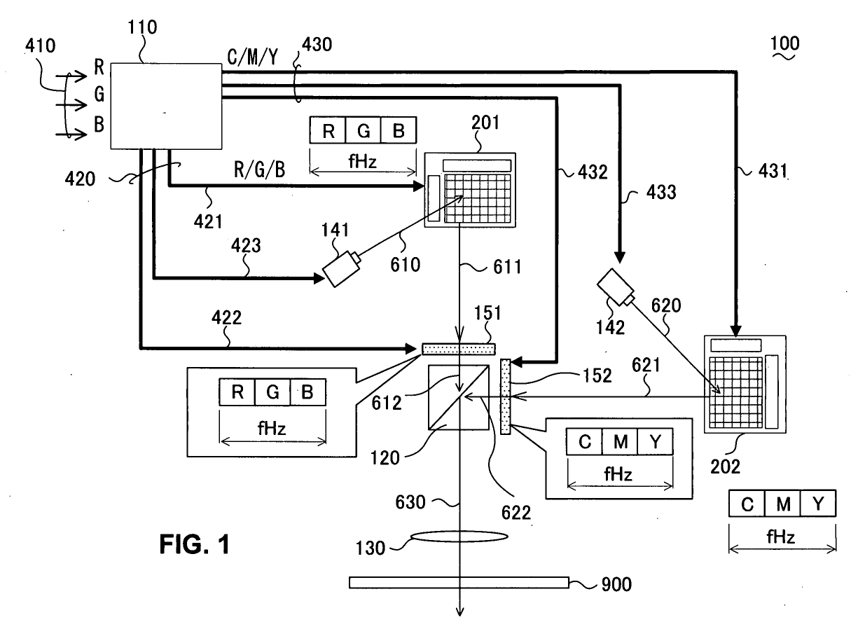

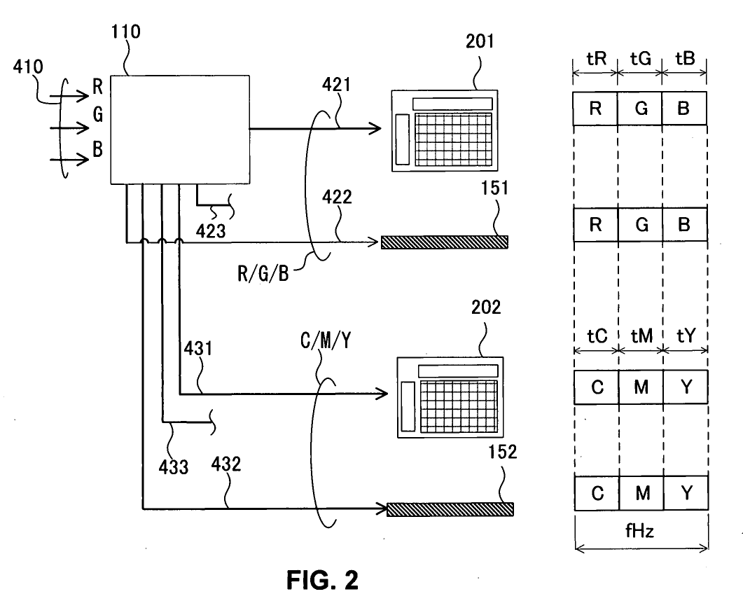

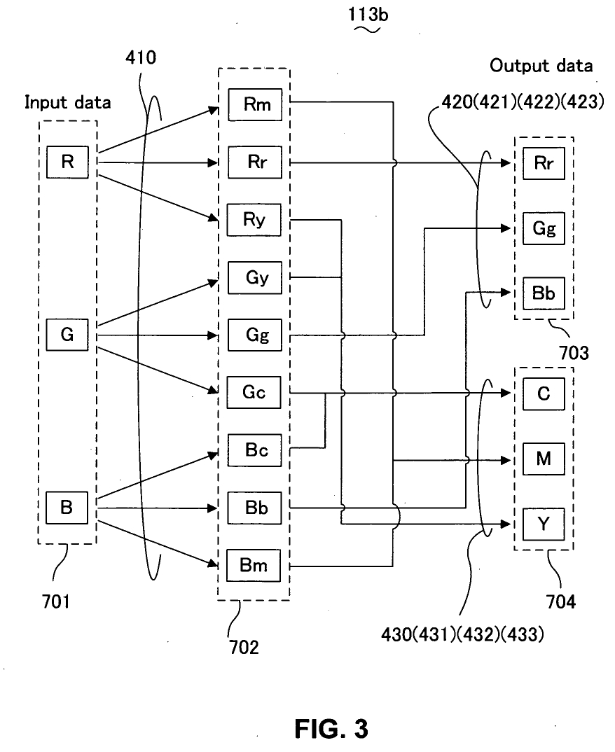

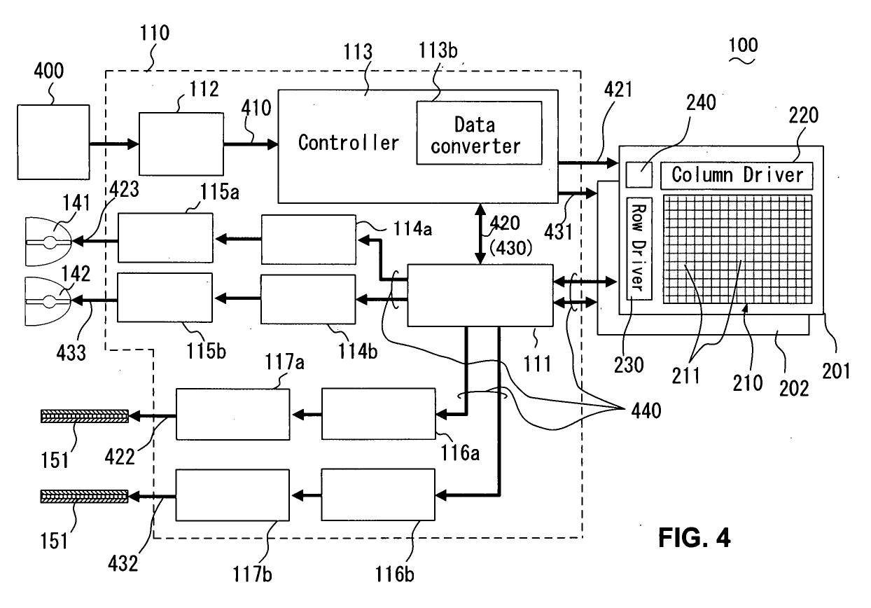

FIG. 1 is a functional block diagram for showing the configuration of a colored video image projection device for projecting a colored video image as one embodiment of the present invention. FIGS. 2 and 3 are functional block diagrams for showing one example of the operational principles of this colored video image projection device. FIG. 4 is a block diagram for showing an exemplary configuration of a control system in the projection display device according to the present embodiment.

As illustrated in FIG. 1, a colored video image projection device 100 of this embodiment comprises a control section 110 implemented as a signal processing device, a first light source 141, a spatial light modulator 201 (SLM) as the first spatial light modulator, a color changing element 151 as the first color changing element, a second light source 142, a spatial light modulator 202 (SLM) as the second spatial light modulator, a color changing element 152 as the second color changing element, a light combining optical system 120 as the light combining device), and a projection optical system 130.

The control section 110 applies a video image data received from a video image source 400 to generate a control signal 420 that includes a first spatial light modulator control signal 421, a first color changing element control signal 422, and a first light source control signal 423. The control section further generates another control signal 430 that includes a second spatial light modulator control signal 431, a second color changing element control signal 432, and a second light source control signal 433. FIG. 1 therefore shows the control section 110 controls a first light source 141, a first spatial light modulator 201, a first color changing element 151, a second light source 142, a second spatial light modulator 202, and a second color changing element 152.

According to the present embodiment, FIG. 4 shows the colored video image projection device 100 implemented with the control section 110 of, that comprises a sequencer 111, a frame memory 112, a controller 113, light source control sections 114a and 114b, light source drive circuits 115a and 115b, color changing element controller 116a and 116b, and color changing element drive circuits 117a and 117b.

In FIG. 4, a sequencer 111 comprises a microprocessor, controls the operational timing for the entire control section 110, and also controls the operational time sequences of the first spatial light modulator 201, the second spatial light modulator 202, the first color changing element 151, and the second color changing element 152.

As described below, according to the present embodiment, the sequencer 111 sends out control signals such as a subframe synchronizing signal 440 for each color to control the spatial light modulator 201, color changing element 151, light source 141, spatial light modulator 202, color changing element 152, and light source 142 to synchronize the operations in one frame of display period (i.e. modulation period) (fHz). According to an exemplary embodiment, one frame of display period (f) is to operate the display system with a frequency f, where the frequency f may be adjusted to f=60 Hz, 90 Hz, 120 Hz, or 240 Hz.

The frame memory 112 may be implemented to hold one frame of input digital video data 410 sent from an external source of data, such as the video image data source 400. The input digital video data 410 is updated every time one frame of display is completed.

The controller 113 processes the input digital video data 410 read from the frame memory 112 at a data conversion circuit 113b for generating the output data that is applied as a mirror driving signal of the spatial light modulator control signal 421 to the spatial light modulator 201.

In other words, as illustrated in FIG. 3, the data conversion circuit 113b performs an operation to generate the control signal 420, composed of primary color data, and the control signal 430, composed of complementary color data such as C/M/Y corresponding to each piece of the primary color data (R/G/B). The control signals 420 and 430 are generated from the three primary color data components RIG/B contained in the input digital video data 410 inputted from the video image data source 400.

In this exemplary embodiment, the data conversion circuit 113b comprises an input latch register 701, a color mixture register 702, a primary color output latch register 703, and a complementary color output latch register 704.

The data conversion circuit 113b expands each piece of color data R/G/B of the input digital video data 410 latched in the input latch register 701 to generate red (Rm/Rr/Ry), green (Gy/Gg/Gc), and blue (Bc/Bb/Bm) at the color mixture register 702, and generates M (i.e., magenta) from Rm and Bm, Y (i.e., yellow) from Ry and Gy, C (i.e., cyan) from Gc and Bc, storing them in the complementary color output latch register 704 and outputting them as the control signal 430.

Furthermore, the data conversion circuit 113b stores the Rr/Gg/Bb data generated at the color mixture register 702 into the primary color output latch register 703 and outputs the data as the control signal 420.

The light source control section 114a applies the instructions received from the sequencer 111 to control the emission of illumination light 610 (first illumination light) at the light source 141 by outputting the light source control signal 423 via the light source drive circuit 115a.

The light source control section 114b applies the instructions received from the sequencer 111 to control the emission of illumination light 620 (second illumination light) at the light source 141 by outputting the light source control signal 433 via the light source drive circuit 115b.

The color changing element controller 116a controls the color changing element drive circuit 117a to control the color changing element 151. Specifically, by inputting the color changing element control signal 422 into the color changing element 151 on the basis of the frame synchronizing signal 440 input from the sequencer 111, the color changing element controller 116a controls the timing to sequentially change, in the order of red (R), green (G) and blue (B), the color of reflection light 611 transmitted through the color changing element 151 during an adjustable period of time.

The color changing element controller 116a inputs the color changing element control signal 432 into the color changing element 152 via the color changing element drive circuit 117b, the color changing element controller 116b controls the timing to sequentially change, in the order of C/M/Y, the color of reflection light 621 transmitted through the color changing element 152 during an adjustable period of time.

In the present embodiment, as illustrated in FIG. 2, the control section 110 generates the control signals 420 and 430 to synchronize the timing of switching the luminance and coloring of the R/G/B color data. These functions are carried out by the spatial light modulator 201 and the color changing element 151 on the primary color side (red display period tR, green display period tG, blue display period tB). Similarly, the timing of switching the luminance and coloring of the C/M/Y color data carried out by the spatial light modulator 202 and the color changing element 152 on the complementary color side (cyan display period tC, magenta display period tM, yellow display period tY).

Although not specifically shown, the color changing element 151 according to the present embodiment can be configured with, for example, a plurality of polarization switches for respectively switching the polarization state of a plurality of wavelength regions (i.e., colors) of the reflection light 611 at an adjustable timing by means of an electric control. In this operation, a plurality of polarizing plates, through which only one color, R, G, and B, in a specific polarization state can be transmitted, are arranged on the subsequent stage of the polarization and switches in response to the control.

Therefore, the color changing element 151 functions as an active color switch for an electric control that selectively and rapidly switches the color (R/G/B) of the reflection light 611 transmitted through the color changing element 151 at an adjustable timing by means of the color changing element control signal 422 externally inputted so as to emit the reflection light 611 as colored light 612 (first modulated light).

Similar to the color changing element 151, the color changing element 152 is configured with a plurality of polarization switches for respectively switching a polarization state of a plurality of wavelength regions (i.e., colors) of the reflection light 621 at an adjustable timing by means of an electric control, and a plurality of polarizing plates, through which only one color of C/M/Y in a specific polarization state can be transmitted, arranged on the subsequent stage of the polarization, switches in response to the controls.

Therefore the color changing element 152 functions as an active color switch for an electric control that selectively and rapidly switches the color (C/M/Y) of the reflection light 621 transmitted through the color changing element 152 at an adjustable timing by means of the color changing element control signal 432 externally inputted so as to emit the reflection light 621 as colored light 622 (second modulated light).

This invention thus discloses a method for determining the ratio of a red display period tR, green display period tQ and blue display period tB (cyan display period tC, magenta display period tM, and yellow display period tY). The ratio of the display time of each of the colors can be adjusted depending on, for example, the spectral luminous efficiency of a human eye when viewing a displayed video image or a property such as the ratio of each of the colors in an input image.

As illustrated in FIG. 4, each of the spatial light modulators 201 and 202 according to the present embodiment may be implemented as a digital micromirror device (DMD). In other words, each of the spatial light modulators 201 and 202 comprises a pixel array 210, a column driver 220, a row driver 230, and an external interface section 240. In the pixel array 210, a plurality of pixel sections 211 are arranged in a lattice pattern at positions where a bit line (not shown), extended vertically from the column driver 220, crosses a word line (not shown) extended horizontally from the row driver 230.

Each one of the pixel sections 211 comprises a mirror. When the mirror tilts to an ON position, the reflection light 611 (reflection light 621) is reflected in the direction to reflect the reflection light 611 to the color changing element 151 (color changing element 152). When the mirror tilts to an OFF position, the reflection light 611 (reflection light 621) is directed in the direction away from the color changing element 151 (color changing element 152).

The spatial light modulator control signal 421 and similarly the spatial light modulator control signal 431 controls the luminance of the colors R/G/B (C/M/Y) by controlling the time ratio of the ON state and OFF state of the mirror in each period of red display period tR, green display period tG, and blue display period tB. Similar control methods are applied to control the luminance of the cyan display period tC, magenta display period tM, yellow display period tY.

The light combining optical system 120 is implemented with a dichroic prism. The dichroic prism combines the colored light 612 and 622 to emit a combined projection light 630. In the example shown in FIG. 1, since the colored light 612 and 622 respectively represent a primary color and a complementary color, a white color is generated as a result of combining the maximum intensity of the lights.

The projection optical system 130 is implemented in an exemplary embodiment with an enlarging optical system. The enlarging optical system enlarges and projects the projection light 630 from the light combining optical system 120 onto a screen 900.

The following is a description of the operation of the colored video image projection device 100 according to the present embodiment.

On the primary color side, the illumination light 610 irradiated from the light source 141 to the spatial light modulator 201 is modulated at the spatial light modulator 201, and subsequently the illumination light 610 is reflected as the reflection light 611. This reflection light 611 is transmitted through the color changing element 151 and is therefore colored in the order of the primary colors of R/G/B in one frame of display period. Then, the reflection light 611 is incident to the light combining optical system 120 as the primary colored light 612.

On the complementary color side, the illumination light 620 irradiated from the light source 142 to the spatial light modulator 202 is modulated at the spatial light modulator 202, and subsequently the illumination light 620 is reflected as the reflection light 621. This reflection light 621 is transmitted through the color changing element 152 and is therefore synchronized with the display period of the R/G/B light on the primary color side so as to be colored in the order of C/M/Y in one frame. Then, the reflection light 621 is incident to the light combining optical system 120 as the complementary colored light 622.

The light combining optical system 120, configured with an optical element such as a polarization beam splitter (PBS), combines the lights generated from the two spatial light modulators by setting different deflecting directions of light from the light sources 141 and 142.

In the light combining optical system 120 sequentially processes and combines the colored light 612, transmitted in the order of the primary colors R/G/B, and the colored light 622, transmitted in the order of the complementary colors C/M/Y corresponding to the primary colors R/G/B. The combined light is transmitted to the projection optical system 130 as the projection light 630. Then, the projection light 630 is projected onto the screen 900 via the projection optical system 130.

As described above, the colored video image projection device 100 according to the present embodiment combines, using at least two spatial light modulators 201 and 202 for modulating and reflecting two reflections lights, i.e., the reflection lights 611 and 621, to project and display a single video image.

According to the present embodiment, one frame of display period of a video image, the colored video image projection device 100 displays a video image by projecting a first primary color (red, for example) from one spatial light modulator 201, and displays a video image by projecting the first complementary color (cyan, for example) from the other spatial light modulator 202.

Similarly, according to the present embodiment, in another primary color display period of green or blue, the video image projection device 100 controls two spatial light modulators 201 and 202 to sequentially project a complementary color such as the magenta or yellow colors corresponds to the primary color.

According to the present embodiment, the color video image projection device 100 displays a video image by focusing the light modulated by the two spatial light modulators 201 and 202 onto one spot using the light combining optical system 120 and by projecting the light onto the screen 900 using the projection optical system 130. Therefore a video image displayed with color of increased brightness and reduced artifacts by substantially eliminating the color break is achieved.

As described above, the colored video image projection device 100 according to the present embodiment uses the two spatial light modulators 201 and 202. This configuration reduces the complexity and cost of producing the technology. It combines primary-color light and complementary-color light corresponding to the primary-color light, and allows for the projection of brightly colored video images with few image artifacts such as a color break.

Although the color changing elements 151 and 152 are arranged in the projection light path, they may also be placed in the illumination path of illumination light from the light sources 141 and 142. In this case, light fluxes, having predetermined colors modulated by the spatial light modulators 201 and 202, are combined and projected by a color combining prism.

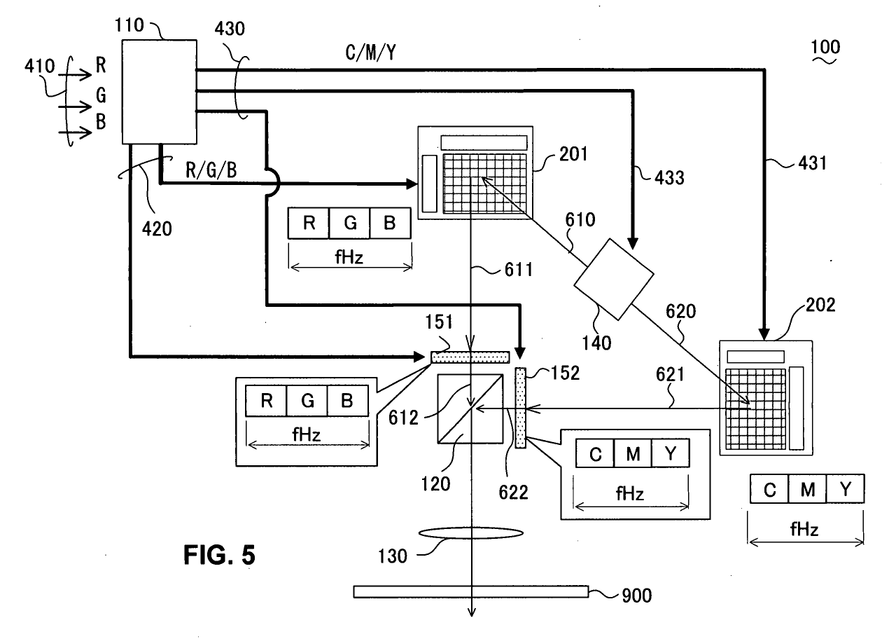

FIG. 5 is a functional block diagram showing an exemplary modification of the colored video image projection device 100 according to the present embodiment.

In this configuration with the exemplary modification illustrated in FIG. 5, the illumination light 610 and 620 are emitted from a single light source 140 to each of the optical systems on the primary color side and the complementary color side. This configuration reduces the number of light source, further simplifies the structure, and lowers the production cost. In this embodiment, a DMD is used as the spatial light modulators 201 and 202. Furthermore, a transmissive liquid crystal device can also be implemented instead of a DMD. Alternatively, a reflective liquid crystal device can be used as the spatial light modulators 201 and 202.

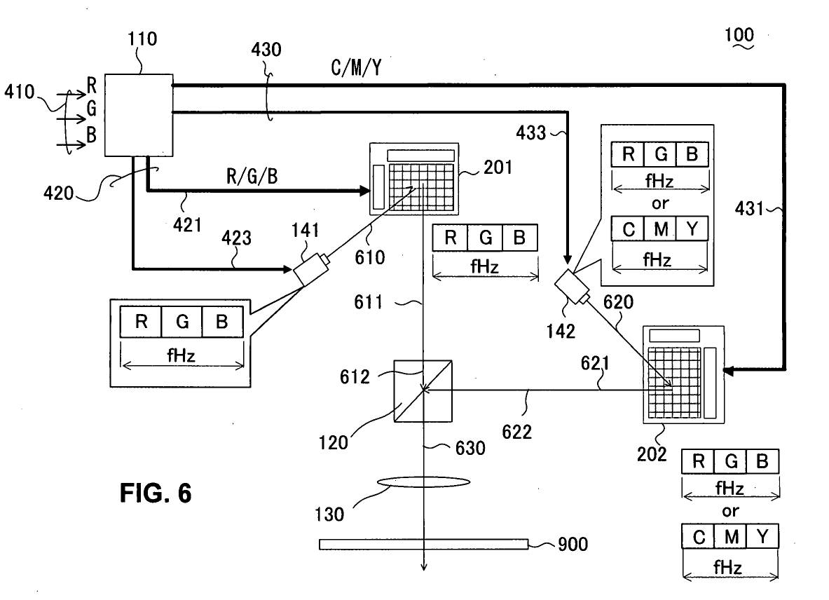

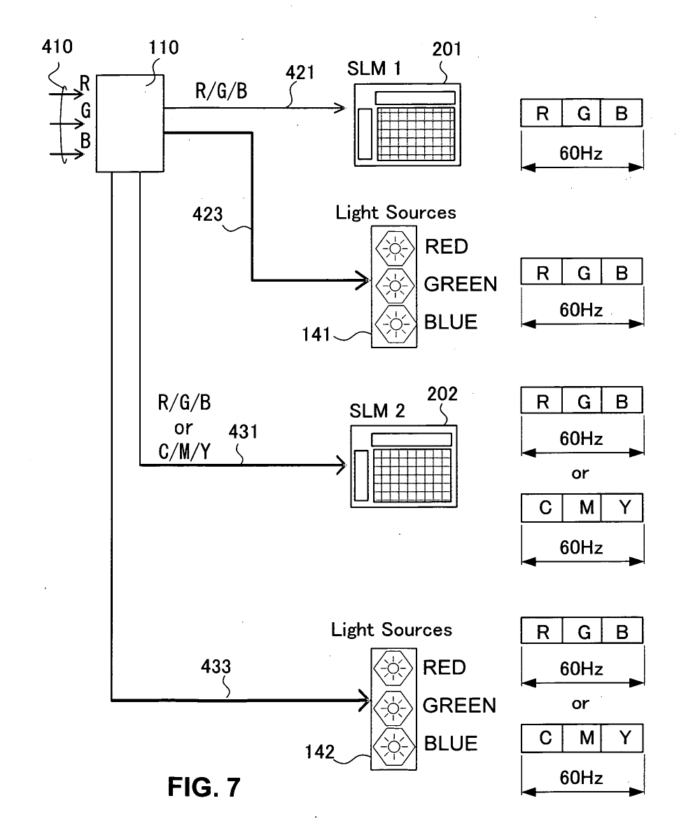

FIGS. 6 and 7 illustrate another embodiment of the present invention as described below.

In this embodiment, instead of using the color changing elements 151 and 152 described above, the display period of the colors R/G/B is controlled by controlling the emitting state of the light sources 141 and 142.

Therefore, instead of the color changing elements 151 and 152 illustrated in FIG. 1 above, the colored video image projection device 100 illustrated in FIG. 6 is comprised of the light sources 141 and 142, which can generate the three colors R/G/B.

The colored video image projection device 100 illustrated in FIG. 6 irradiates illumination light having a single color selected from among the RGB colors, their complementary colors (CMY), and white color (W) or color-sequential illumination light (illumination light 610 and 620) having a plurality of colors to each of the two spatial light modulators 201 and 202. The two spatial light modulators 201 and 202 modulate the illumination light 610 and 620 respectively emitted from the two light sources 141 and 142.

As illustrated in FIG. 7, the control section 110 applies an inputted video image signal includes the input digital video data 410 to control the illumination device and the two SLMs. s A display frame of a video image modulated with two spatial light modulators 201 and 202 is divided into a plurality of color sub-frames. The light emitted from the light sources 141 and 142 is modulated by the SLMs and combined by the light combing optical system 120 to generate into the projection light to display a video image.

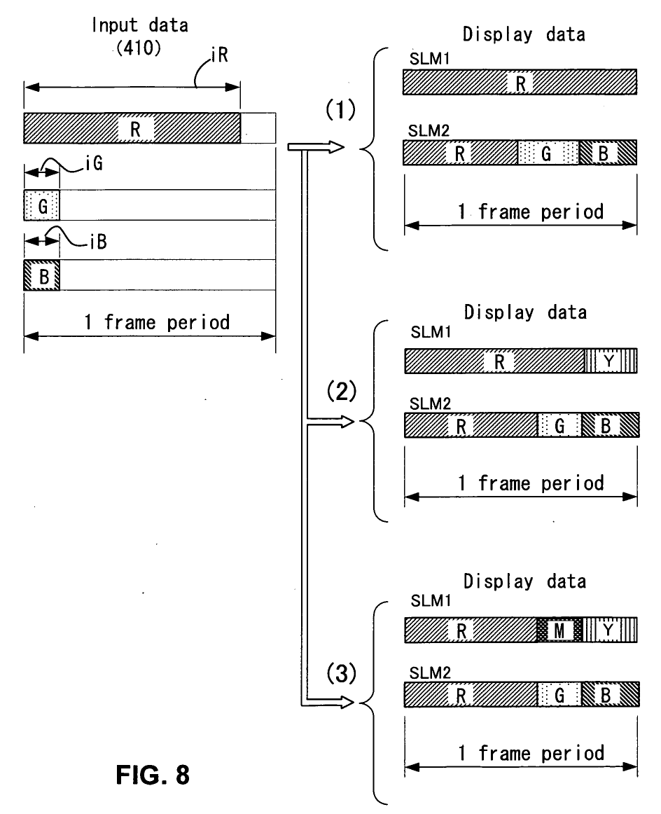

FIG. 8 is a functional block diagram illustrating an example of controlling each of the colors R/G/B projected by the colored video image projection device 100 illustrated in FIG. 6.

Consider a specific example for displaying the images of a sunset scene. Since the image of the sunset scene has a high rate of occurrence of red color and the red color signals are consecutively inputted as the input digital video data 410. The brightness of a displayed video image is increased by increasing the rate of occurrence of red color in color subframes displayed by the two spatial light modulators 201 and 202.

Referring to FIG. 8, the “Input data” on the left side indicates the rate of occurrence of a color contained in R/G/B video image data (input digital video data 410) inputted into the signal processing device 110. Specifically, the diagram indicates that the rate of occurrence of the average value of the brightness of an R/G/B color is calculated by the signal processing device 110 on the basis of the data of each pixel in video image data input in a specific period.

FIG. 8 shows the example of a color control (1) based on the rate of occurrence of a color. The signal processing device 110 assigns color sub-frames of the R/G/B colors to the two spatial light modulators 201 and 202. Specifically, the overall brightness of the displayed video image is increased by increasing the ratio of the display time of the red color R. This process reduces the time required to process the other colors. Therefore, a longer time can be spent on processing the R color and thus allowing for an increase in the number of displayed gray scale gradations for the R color. Higher number of gray scale gradations of the red color is displayed than the other colors.

FIG. 8 also shows the example of a color control (2) based on the rate of occurrence of a color. The color sub-frames of the R/G/B and yellow are assigned to the two spatial light modulators 201 and 202. Yellow light is a generated from the combination of R and G Display data of the color subframe period of yellow is generated on the basis of the input data of R and G. In addition, the color break phenomena caused by blue or yellow light is reduced by overlapping the display periods of the yellow and blue sub-frames. In this period, since the color of the illumination light is visually perceived as being close to white, white color light having a predetermined luminance may be projected by reducing the amount of the color change in projection light.

FIG. 8 shows the example of a color control (3) based on the rate of occurrence of a color. The color subframes of R/G/B, magenta, and yellow are assigned to the two spatial light modulators 201 and 202. Yellow is a color generated from the combination of R and G. Magenta is a color generated from the combination of R and B. Display data of the color subframe period of yellow is generated on the basis of the input data of R and G Display data of the color subframe period of magenta is generated on the basis of the input data of R and B.

Additionally, the color break phenomena caused by magenta light, green light, blue light, and yellow light can be reduced with the display periods of the magenta and green subframes overlaps with each other and by making the display periods of the yellow and blue subframes overlapping with each other.

The modulation periods of the red light coincide with each other. Each of the SLMs can change the number of gray scale gradations so that the SLM 1 (i.e. spatial light modulator 201) displays the gray scale gradations in a bright portion of red and the SLM 2 (i.e. spatial light modulator 202) displays the gray scales gradations in a dark portion of red. SLMs 1 and 2 can perform different modulation controls.

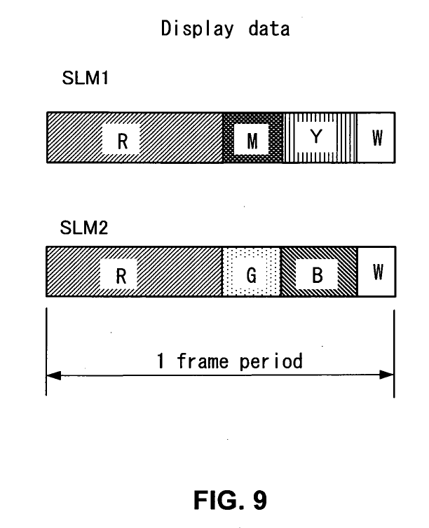

In FIG. 9, color subframes of a white color are further assigned to the two spatial light modulators 201 and 202, as in the example of the color control (3) in FIG. 8. White colored light is generated by combining R, G. and B light. The brightness of a displayed video image can be further increased by arranging the period of the white color (white) as shown in FIG. 9. In this period, the brightness of the display can be twice as high as the brightness when using only one of the SLMs. In addition, the number of gray scale gradations of the white color can be adjusted to be higher than that of the other colors. Alternatively, in each of the two SLMs, the number of gray scales gradations of the white color may be the same as that of gray scale gradations of the other colors. Each of the SLMs can display different gray scale gradations and dynamic range areas, such as a dark portion and a bright portion of a video image signal of the white color.

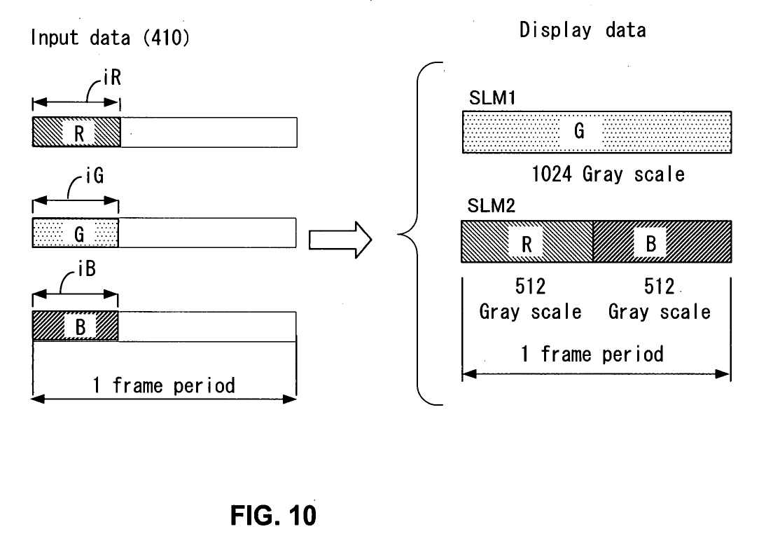

FIG. 10 is another functional block diagram showing an example of controlling each color of the R/G/B color data of the colored video image projection device 100 illustrated in FIG. 6.

Sensitivity of the human eye to the wavelength of a color is known as spectral luminous efficiency. It is known that the sensitivity to G (green) color is the highest among the primary colors R, G, and B. In FIG. 10, the two spatial light modulators have different ratios of display periods so that the display period of a green color is longer than that of the other colors, corresponding with the spectral luminous efficiency. In correspondence with the rate of the display period, the number of displayed gray scale gradations of the green color is 1024, and the number of displayed gray scale gradations of the other colors is 512.

In this example, it is possible to compensate for the longer display period of green in the color balance by weakening the light source intensity of green or by strengthening the light source intensity of red and blue. When a micromirror device is used as a spatial light modulator, it is also possible to reduce the intensity of light projected in the color subframe period of a green color by using the oscillation modulation control described later.

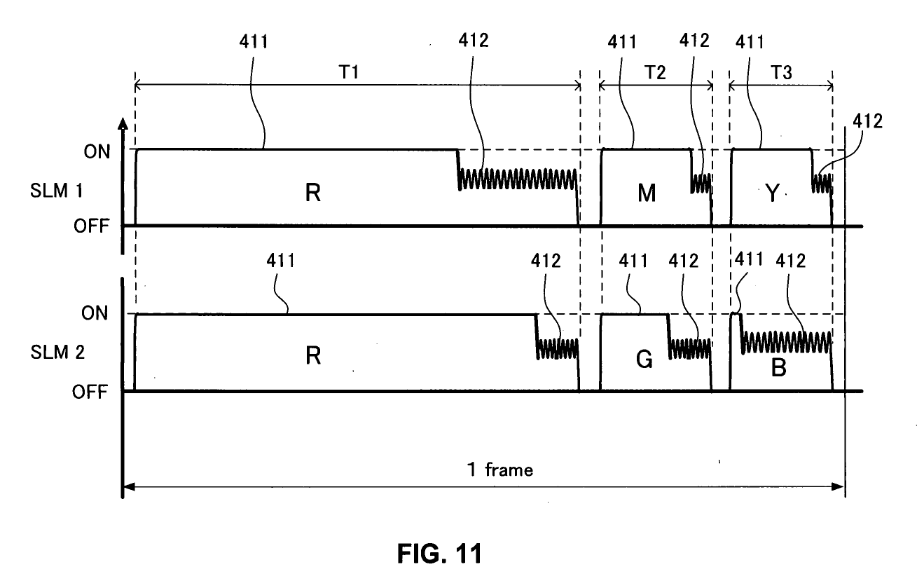

According to the example in FIG. 11, the SLMs (spatial light modulators 201 and 202) have micromirrors arranged in an array. Each of the mirrors is controlled to be in an ON modulation state, OFF modulation state, and a modulation state created by oscillation.

Under the modulation state created by oscillation, a display can be projected using a lower intensity of modulated light than the intensity of modulated light projected under the ON modulation state. Therefore the display will have a larger number of gray scale gradations than when a control is performed using only the ON modulation state and OFF modulation state.

In addition, the combination of the ON control and the oscillation control enables the adjustment of a modulation time to obtain a desired intensity of light. When a desired intensity of light is projected for a certain pixel, a modulation control with this combination can be performed for a longer period than when using only the ON control.

FIG. 11 is a timing diagram for illustrating a method for arranging the timing sequences of the modulation periods of a modulation control executed for each pixel in each color subframe period of each of the two spatial light modulators 201 and 202 to conform to a predetermined display pattern. In FIG. 11 the combination of the ON/OFF control and the oscillation control described above is used for the color subframe configuration illustrated in the example of the color control (3) in FIG. 8 above. In other words, in mirror modulates the predetermined pixels corresponding to each other between the two spatial light modulators 201 and 202 (SLMs 1 and 2). The control section 110 performs the pixel control of the spatial light modulators 201 and 202 for achieving specific time sequence arrangements. The modulation period of each of the color subframes of R in the predetermined pixel is represented by T1. In regard to the predetermined pixel, both the modulation time of the color subframe of M (Magenta) of the SLM 1 and the modulation time of the color subframe of G of the SLM 2 are represented by T2. In regard to the predetermined pixel, both the modulation time of the color subframe of Y (Yellow) of the SLM 1 and the modulation time of the color subframe of B of the SLM 2 are represented by T3.

In this case, each of the lengths of T1, T2, and T3, the ON/OFF control (first mirror control signal 411) and the oscillation control (second mirror control signal 412) performed by the micromirror 212 are coordinated to modulate illumination light. By arranging the modulation periods (T1, T2, T3) for corresponding pixels close to each other between the two spatial light modulators 201 and 202 the color break in each pixel that occurs when the viewer's eye views a difference in the modulation times of each piece of color illumination light of each pixel, is reduced.

FIG. 11 illustrates an exemplary configuration of the spatial light modulators 201 and 202's to illustrate the coordination between the ON/OFF states and the oscillating state of a mirror.

In the following description, since the spatial light modulators 201 and 202 have the same configuration, they are generically referred to as a spatial light modulator 200.

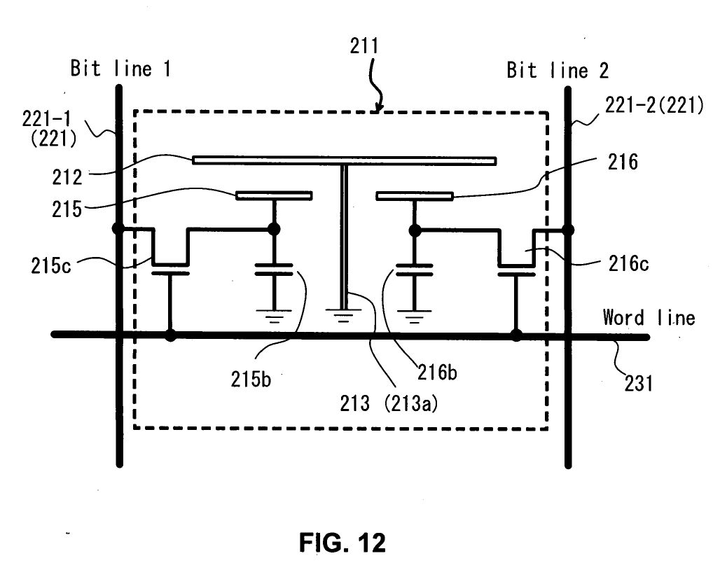

FIG. 12 is a functional block diagram showing an exemplary configuration of a pixel section configuring the spatial light modulator according to the present embodiment that can achieve the control illustrated in FIG. 11 above.

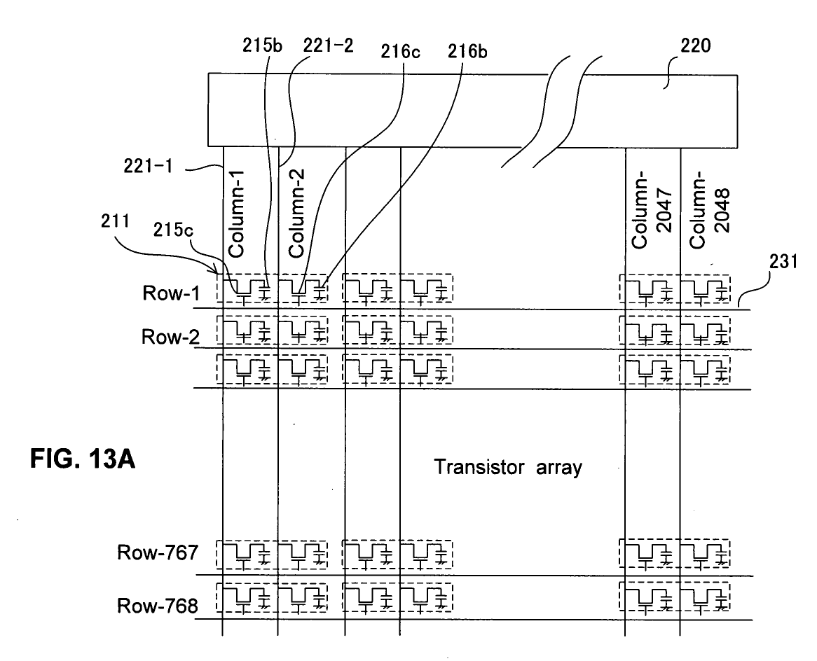

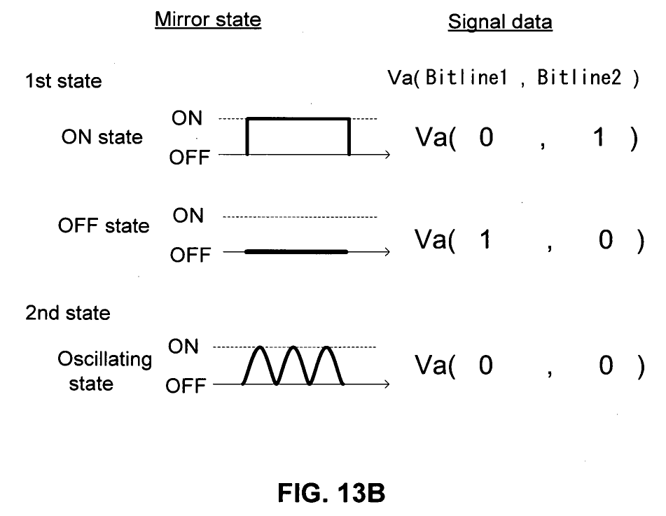

FIG. 13A is a functional block diagram showing an exemplary configuration of the pixel array of the spatial light modulator according to the present embodiment.

FIG. 13B is a diagram showing the relationship between voltage applied to an electrode and the state of a micromirror of the spatial light modulator according to the embodiment of the present invention.

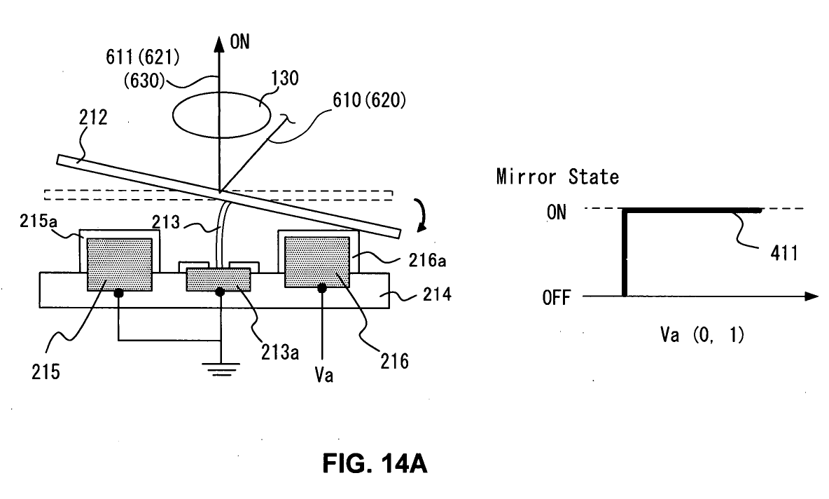

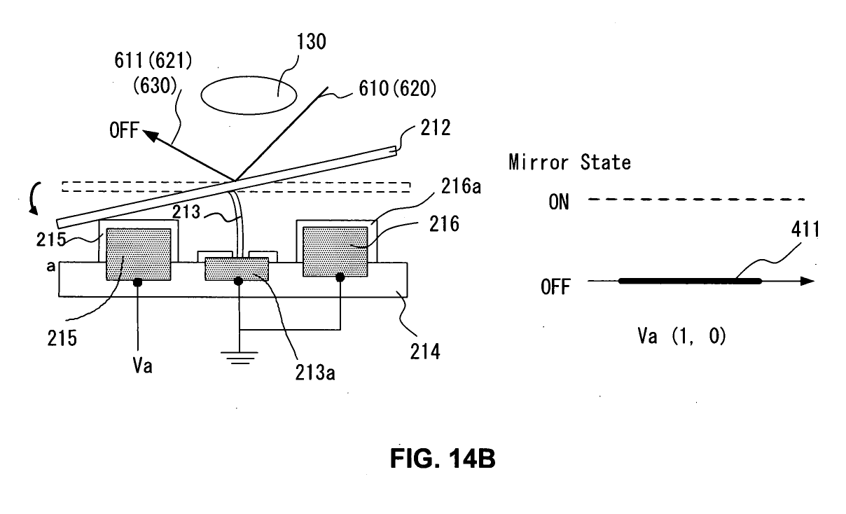

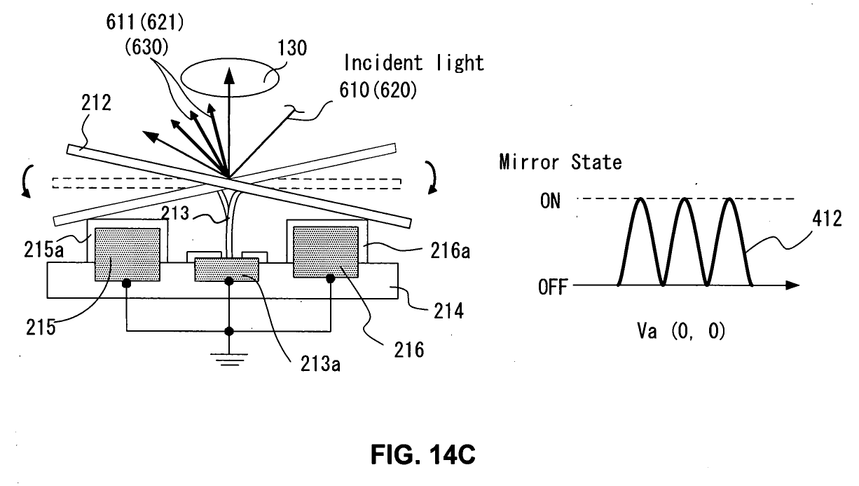

FIG. 14A is a diagram for showing an example of controlling the ON state of the micromirror implemented in the pixel section illustrated in FIG. 12A. FIG. 14B is a diagram showing an example of controlling the OFF state of the micromirror implemented in the pixel section illustrated in FIG. 12A. FIG. 14C is a diagram showing an example of controlling the oscillating state of the micromirror implemented in the pixel section illustrated in FIG. 12A.

As illustrated in FIGS. 4 and 13A, the spatial light modulator 200 according to the present embodiment comprises the pixel array 210, the column driver 220, the row driver 230, and the external interface section 240.

In the exemplary configuration of the spatial light modulator 200 illustrated in FIG. 13A, two bit lines 221-1 and 221-2, required for the control of each of the pixel sections 211, are controlled by means of the column driver 220.

In the pixel array 210, a plurality of pixel sections 211 are arranged in a lattice pattern at each of the positions where the bit line 221, vertically extended from the column driver 220, crosses a word line 231 horizontally extended from the row driver 230.

As illustrated in FIGS. 12, 14A to 14C, each of the pixel sections 211 comprises the micromirror 212 that is supported on a substrate 214 via a hinge 213 such that the mirror may be controlled to deflect to different tilt angles.

On a substrate 214, an OFF electrode 215 and OFF stopper 215a, and an ON electrode 216 and ON stopper 216a are arranged symmetrically across the hinge 213, further comprising a hinge electrode 213a.

When a predetermined electrical potential is applied to the OFF electrode 215, the OFF electrode 215 draws the micromirror 212 by a Coulomb force to deflect and tilt to an angular position in contact with the OFF stopper 215a. The illumination light 610 (620) incident to the micromirror 212 is reflected to a light path in an OFF direction away from the optical axis of the projection optical system 130.

When a predetermined electrical voltage is applied to the ON electrode 216, the ON electrode 216 draws the micromirror 212 by a Coulomb force to deflect and tilt to an angular position in contact with the ON stopper 216a. The illumination light 610 (620) incident to the micromirror 212 is reflected to a light path in an ON direction along the light axis of the projection optical system 130.

The OFF electrode 215 is connected to an OFF capacitor 215b. This OFF capacitor 215b is connected to the bit line 221-1 via a gate transistor 215c.

The ON electrode 216 is connected to an ON capacitor 216b. This ON capacitor 216b is connected to the bit line 221-2 via a gate transistor 216c.

The signals transmitted on the wordline 231 control the turning ON and Off of the gate transistors 215c and 216c.

In other words, when the pixel sections 211 in a horizontal column along any given word line 231 are simultaneously selected and the charging and discharging of an electric charge to/from the OFF capacitor 215b and the ON capacitor 216b are controlled by the signals transmitted on the bit lines 221-1 and 221-2, the switching of the ON/OFF states of the micromirror 212 in the individual pixel sections 211 in the horizontal column is individually controlled.

The external interface section 240 comprises a timing controller and a parallel/serial interface. The timing controller selects a horizontal column of pixel sections 211 by means of the word line 231 based on a scan timing control signal outputted from the control section 110.

The parallel/serial interface provides a modulation control signal for the column driver 220. Each pixel element (pixel section 211) of the spatial light modulator 200 comprises a micromirror 212 that is controlled under any one of the ON/OFF states, the oscillating state, and the intermediate state.

In the present embodiment, the ON/OFF states are controlled by the first mirror control signal 411 outputted from the control section 110, and the oscillating state and the intermediate state are controlled by the second mirror control signal 412 outputted from the control section 110.

The following is the description of the basic control of the micromirror 212 of the spatial light modulator 200 according to the present embodiment.

In FIG. 13B, voltage applied to the OFF electrode 215 and the ON electrode 216 via a bit line is regulated and the state of a micromirror corresponding to the voltage is regulated.

Va (1,0) indicates that a predetermined voltage Va is applied to the OFF electrode 215 via the bit line 221-1 and that the predetermined voltage Va is not applied to the ON electrode 216 via the bit line 221-2. In this case, the micromirror 212 is controlled to be in the OFF state.

Va (0,1) indicates that voltage is not applied to the OFF electrode 215 via the bit line 221-1 and that a predetermined voltage Va is applied to the ON electrode 216 via the bit line 221-2. In this case, the micromirror 212 is controlled to be in the ON state.

Va (0,0) indicates that a voltage Va is not applied to either the OFF electrode 215 or the ON electrode 216 via the bit lines 221-1 and 221-2. In this case, the micromirror 212 is controlled to be in the oscillating state.

FIGS. 14A, 14B, and 14C show a basic example of the configuration of the pixel section 211 constituted by the micromirror 212, the hinge 213, the OFF electrode 215, and the ON electrode 216 and show a basic example of a control when the micromirror 212 is controlled to be in the ON/OFF states and the oscillating state.

In FIG. 14A, the micromirror 212 is tilted to the ON electrode 216 from a neutral state and goes into the ON state by the application of a predetermined voltage Va to the ON electrode 216 (Va(0,1)). When the micromirror 212 is in the ON state, the reflection light 611 (612), is directed towards the projection optical system 130 so that it is projected as the projection light 630. The right side portion of FIG. 14A shows the intensity of light that is projected under the ON state.

In FIG. 14B, the micromirror 212 is tilted to the OFF electrode 215 from the neutral state and goes into the OFF state by the application of the predetermined voltage Va to the OFF electrode 215 (Va(1,0)). When the micromirror 212 is in the OFF state, the reflection light 611 (612) is directed away from the projection optical system 130. The right side portion of FIG. 14B shows the intensity of light that is projected under the OFF state.

In FIG. 14C, the micromirror 212 freely oscillates with the maximum amplitude of oscillation between a tilting position in which the micromirror 212 abuts the ON electrode 216 (Full ON) and a tilting position in which it abuts the OFF electrode 215 (Full OFF) (Va(0,0)).

The illumination light 610 (620) is irradiated to the micromirror 212 at a specific angle. A portion of the illumination light 610 (620) is reflected in an ON direction. Another portion of the illumination light 610 (620) is reflected in the direction that is midway between the ON direction and an OFF direction. These reflections are incident to the projection optical system 130 for contributing the light intensity for displaying an image as part of the projection light 630. The right side portion of FIG. 14C shows the intensity of light that is projected under the oscillating state of the micromirror 212.

In other words, when the micromirror 212 in FIG. 14A is in the ON state, the light fluxes of the reflection light 611 (612) travel in the ON direction, in which essentially all of the light is captured by the projection optical system 130, and projected as the projection light 630.

When the micromirror 212 in FIG. 14B is in the OFF state, the reflection light 611 (612) transmits in the OFF direction along a direction away from the direction of the projection optical system 130. The light reflected in the OFF state is transmitted separately and away from the projection light 630.

When the micromirror 212 in FIG. 14C is in the oscillating state, a portion of the light flux of the reflection light 611 (612), the diffraction light, and the scattered light of the reflection light 611 (612) are captured by the projection optical system 130 and projected as the projection light 630.

In the examples in FIGS. 14A, 14B, and 14C described above, voltage Va represented by a binary value of 0 or 1 is applied to each of the OFF electrode 215 and the ON electrode 216. It is possible to increase the Coulomb force generated between the micromirror 212 and the OFF electrode 215, and between the micromirror 212 and the ON electrode 216, by representing the value of Va with a higher value. In this way, it is possible to more finely control the tilting angle of the micromirror 212.

In the examples in FIGS. 14A, 14B, and 14C described above, in addition, the micromirror 212 (hinge electrode 213a) uses a ground potential. It is possible to more finely control the tilting angle of the micromirror 212 by applying an offset voltage to the micromirror 212.

As described below, in the present embodiment, when the micromirror 212 is between the ON state and the OFF state, Va (0,1), Va(1,0), or Va(0,0) is applied at a specified time. In this way, it is possible to generate a free-oscillation that has smaller amplitude than the maximum amplitude of the oscillation between the ON electrode and OFF electrode and this causes finer intermediate gray scale gradations.

Note that the present invention can be altered in various ways within the scope of the present embodiment and is not limited to the above described embodiment.

According to the present invention, a system configuration and method for projecting a brightly colored video image having no image artifacts, such as color breaks, is provided, without the structure becoming overly complex and without raising the cost of producing the structure.

Further effects such as those shown below can be obtained.

1) There are, by means of two SLMs, configured and displayed color subframes of the primary colors and other colors (complementary colors) obtained by combining the primary colors at an optimum ratio for a video image to be displayed. This can provide a display having high luminance. In addition, it is possible to increase the number of displayed gray scale gradations of a color by increasing its ratio of display in proportion to other colors.

2) By combining the ON/OFF control and the oscillation control, there is adjusted a modulation time of each mirror in the subframe periods that are synchronized with each other between the two SLMs. In this way, differences between the modulation times, for each pixel, of the two mirrors are reduced. Therefore, color breaks in each pixel, which are perceived by a viewer due to a difference between the modulation times, can be reduced.

3) The color break phenomena can further be reduced by performing a color sequential display so that a complementary color is displayed by means of one of the two SLMs while a primary color is displayed by means of the other SLM.

What is claimed is:

1. A color display device comprising:
a color-light generation device for generating and projecting at least two light fluxes having at least two different colors wherein the different colors are controlled to change in a time division manner;
at least two spatial light modulators receiving and applying input video image date for modulating the light fluxes for generating modulated lights from each of the spatial light modulators;
an optical device for combining the modulated lights from the spatial light modulators into a combined modulated light and projecting the combined modulated light; and
a controller for controlling the color-light generation device and the spatial light modulators, wherein
the controller controls and adjusts a ratio of a modulation period of each color synchronized with a change of the colors of the light fluxes in the time division manner.

2. The color display device according to claim 1, wherein:
the color-light generation device comprises a plurality of light sources each irradiate a light flux of a color different from a color irradiated from another light source.

3. The color display device according to claim 1 wherein:
the color-light generation device comprises a filter device controllable to change a filter characteristic in a time division manner for filtering a light flux to sequentially generate a light flux of different colors according to the time division manner.

4. The color display device according to claim 1, wherein:
the color-light generation device generates and projects a polarized light flux.

5. The color display device according to claim 1 wherein:
the spatial light modulator is controllable to modulate the light flux by changing a modulation time and to generate a modulated light with an adjustable light intensity.

6. The color display device according to claim 1, wherein:
the color-light generation device generates and project light fluxes with at least the two different colors including a primary color or a complementary color generated from the primary color.

7. The color display device according to claim 1, wherein:
the controller controls and adjusts a ratio of a modulation period of each color and then resets the ratio of the modulation period to a predetermined ratio.

8. The color display device according to claim 1, wherein:
the controller controls and adjusts a ratio of a modulation period of each color and then resets the ratio of the modulation period to a predetermined ratio wherein the predetermined ratio is determined by taking into account a spectral luminous efficiency of a human eye.

9. The color display device according to claim 1, wherein:
the controller controls and adjusts a ratio of a modulation period of each color and then resets the ratio of the modulation period to a predetermined ratio wherein the predetermined ratio is determined based on a brightness of each color controlled by the input video image data.

10. The color display device according to claim 1, wherein:
the controller controls and adjusts a ratio of a modulation period of each color and then resets the ratio of the modulation period to a predetermined ratio wherein the predetermined ratio is controlled and adjusted according to a number of gray scale gradations for each of the colors wherein the predetermined ratio is for one of the colors is different from the predetermined ratio for another color.

11. The color display device according to claim 1, characterized in that:
each of the spatial light modulators further comprises a mirror device for reflecting the light fluxes by controlling a quantity of the reflected light generated in a modulated unit time with at least three different light quantities including a maximum light quantity, an intermediate light quantity, and a minimum light quantity.

12. The color display device according to claim 1, characterized in that:
each of the spatial light modulators further comprises a mirror device for reflecting the light fluxes by controlling a quantity of the reflected light generated in a modulated unit time according to three different states wherein each of the mirror devices is controlled to operate in an ON state, an OFF state, and an oscillating state; and
the color display device further synchronizes the modulation periods of the two spatial light modulators by controlling sequence and times of the mirror devices to operate in the ON, intermediate and OFF states.

13. A method for projecting a colored video image from a projection apparatus comprises a first and a second spatial light modulators by executing in one frame of display period operation steps comprising:
modulating and generating a first modulated light of a primary color from the first spatial light modulator and modulating and generating a second modulated light of a complementary color from the second spatial light modulator and projecting the first and second modulated light to coincide with each other in at least a portion of the one frame of display period; and
modulating and generating a third modulated light of a complementary color from the first spatial light modulator and modulating and generating a fourth modulated light of a primary color from the second spatial light modulator and projecting the third and fourth modulated light to coincide with each other in at least a portion of the one frame of display period.

14. The method for projecting a colored video image according to claim 13, further comprising:
controlling the first and second spatial light modulators to operate with substantially synchronized display periods.

15. A method for projecting a colored video image, from a projection apparatus comprises a first and a second spatial light modulators by executing in one frame of display period operation steps comprising:
modulating and generating a first modulated light of a primary color from the first spatial light modulator and modulating and generating a second modulated light of a complementary color comprising essentially a white color from a second spatial light modulator and combining and projecting the first and second modulated light to coincide with each other in at least a portion of the one frame of display period.

16. The method for projecting a colored video image according to claim 15, further comprising a step of:
controlling and operating the first and second spatial light modulators to have different gray scale gradations for displaying a color of the essentially white color light and for other colors.

17. A colored video image projecting system comprises:
a light source for emitting a first and second illumination light;
a first mirror device for modulating the first illumination light in a plurality of subframe periods assigned to each color;
a second mirror device for modulating the second illumination light in a plurality of subframe periods assigned to each color;
a projection optical system for combining the first modulated light modulated by the first mirror device and the second modulated light modulated by the second mirror device for projecting the combined light;
a signal processing device for applying input video data to control each of the first and second mirror devices to operate in a first or second state, wherein
the signal processing device adjusts a modulation time when the first mirror device is in the first state, a modulation time when the first mirror device is in the second state, a modulation time when the second mirror device is in the first state, and a modulation time when the second mirror device is in the second state to substantially synchronize each of the subframe periods of the first mirror device and each of the subframe periods of the second mirror device.

18. The colored video image projecting system according to claim 17, wherein:
the projection optical system for combining the first modulated light modulated by the first mirror device and the second modulated light modulated by the second mirror device to generate an essentially white combined light.

19. The colored video image projecting system according to claim 17, wherein:
the light source projects a first and a second illumination lights of substantially a same color.

20. The colored video image projecting system according to claim 17, wherein:
each of the first and second mirror devices comprises a mirror, and the signal processing device controls the mirrors to oscillate in the second state.

21. The colored video image projecting system according to claim 17, wherein:
the signal processing device controls the mirror devices to generate an intermediate modulated light between a maximum light quantity and a minimum light quantity in the second state to project a video image with additional levels of controllable light quantities.

22. The colored video image projecting system according to claim 17, wherein:
the signal processing device controls the mirror devices to generate modulated lights of different colors with at least two different gradations of gray scale between modulated lights of different colors from the first and second mirror devices.
